(19) United States
(12) Patent Application Publication
(10) Pub. No.: US 2025/0184374 A1
(43) Pub. Date: Jun. 5, 2025

(54) SYSTEMS AND METHODS FOR INITIATING PEER-TO-PEER TELECONFERENCING

(71) Applicant: CenturyLink Intellectual Property LLC, Denver, CO (US)

(72) Inventors: John R.B. Woodworth, Amissville, VA (US); Dean Ballew, Sterling, VA (US)

(73) Assignee: CenturyLink Intellectual Property LLC, Denver, CO (US)

(21) Appl. No.: 18/960,541

(22) Filed: Nov. 26, 2024

Related U.S. Application Data
(60) Provisional application No. 63/605,081, filed on Dec. 1, 2023.

(51) Int. Cl. H04L 65/1069; H04L 12/18; H04L 65/403; H04L 67/104

(52) U.S. Cl. CPC H04L 65/1069; H04L 12/1831; H04L 65/403; H04L 67/104

(57) ABSTRACT

A computing device of a user that has been invited to participate in a scheduled teleconferencing session may obtain information associated with the teleconferencing session, such as a meeting identifier and/or one or more user identifiers associated with other invitees of the teleconferencing session. The computing device may determine that a cloud-based teleconferencing service associated with the teleconferencing session is unavailable. In response to determining that the cloud-based teleconferencing service is unavailable, the computing device may retrieve internet protocol (IP) addresses of other computing devices (corresponding to other invitees) from a domain name service (DNS) based on the meeting identifier and/or the one or more user identifiers. The computing device may then initiate peer-to-peer connections with the other computing devices using the received IP addresses and participate in the teleconferencing session via the peer-to-peer connections.

### CROSS-REFERENCE TO RELATED APPLICATIONS

This application claims the benefit of U.S. Provisional Application No. 63/605,081 filed Dec. 1, 2023, entitled “Systems and Methods for Initiating Peer-to-Peer Teleconferencing,” which is incorporated herein by reference in its entirety.

### FIELD

One or more aspects of embodiments according to the present disclosure relate to the initiation of peer-to-peer teleconferencing in response to a determination that a connection to a cloud-based teleconferencing service is unavailable.

### BACKGROUND

Teleconferencing services and applications, such as video-conferencing and audio-conferencing services and applications, enable collaboration between multiple participants that may be geographically dispersed. Participants in a teleconferencing session are typically able to stream live video and/or audio of other participants and/or share various types of media with each other. Teleconferencing services are typically hosted using one or more cloud-based servers, with each participant connecting to the cloud-based teleconferencing service via an Internet connection. In some cases, however, the cloud-based teleconferencing service may not be available when a participant attempts to join a teleconferencing session or may become unavailable during a session that is in progress, such as if the cloud-based teleconferencing service itself is (or becomes) unavailable or if an Internet connection to the cloud-based teleconferencing service cannot be established or maintained.

The above information disclosed in this Background section is only for enhancement of understanding of the background of the present disclosure, and therefore, it may contain information that does not form prior art.

### SUMMARY

In an aspect, the present technology includes a method comprising: obtaining a meeting identifier associated with a scheduled teleconferencing session; obtaining a first user identifier corresponding to an invitee of the scheduled teleconferencing session; determining that a cloud-based teleconferencing service associated with the scheduled teleconferencing session is unavailable; in response to determining that the cloud-based teleconferencing service is unavailable, transmitting, to a computer system, the meeting identifier and the first user identifier; receiving, from the computer system, an Internet protocol (IP) address associated with the meeting identifier and the first user identifier; initiating a first peer-to-peer connection with a second computing device that corresponds to the IP address; transmitting, to the second computing device via the first peer-to-peer connection, a first live teleconferencing stream; and receiving, from the second computing device via the first peer-to-peer connection, a second live teleconferencing stream.

In some examples, and in combination with any of the above aspects and examples, the method further includes, after initiating the first peer-to-peer connection with the second computing device, receiving authentication information from the second computing device via the first peer-to-peer connection; and authenticating the second computing device based on the authentication information, wherein transmitting the first live teleconferencing stream to the second computing device is based on authenticating the second computing device.

In some examples, and in combination with any of the above aspects and examples, the method further includes, before detecting that the cloud-based teleconferencing session is unavailable, receiving second authentication information via an Internet connection, wherein authenticating the second computing device comprises determining that the authentication information corresponds to the second authentication information.

In some examples, and in combination with any of the above aspects and examples, the method further includes, before transmitting the first user identifier: establishing an Internet connection to the cloud-based teleconferencing service; and participating in a teleconferencing session with the second computing device via the Internet connection and the cloud-based teleconferencing service, wherein: determining that the cloud-based teleconferencing service is unavailable comprises detecting, during the teleconferencing session with the second computing device, that the Internet connection to the cloud-based teleconferencing service is unavailable, and the first user identifier is transmitted to the computer system based on detecting that the Internet connection to the cloud-based teleconferencing service is unavailable.

In some examples, and in combination with any of the above aspects and examples, determining that the cloud-based teleconferencing service is unavailable comprises determining that an Internet connection to the cloud-based teleconferencing service cannot be established, and the first user identifier is transmitted to the second computing device based on determining that the Internet connection to the cloud-based teleconferencing service cannot be established.

In some examples, and in combination with any of the above aspects and examples, the computer system comprises a domain name system (DNS) server.

In some examples, and in combination with any of the above aspects and examples, the method further includes, before determining that the cloud-based teleconferencing service is unavailable, transmitting, to the computer system, the meeting identifier and a second user identifier corresponding to a user of the first computing device.

In some examples, and in combination with any of the above aspects and examples, the method further includes, while the first peer-to-peer connection is active, determining that the cloud-based teleconferencing service is available; in response to determining that the cloud-based teleconferencing service is available and in accordance with a determination that one or more criteria are satisfied, establishing an Internet connection to the cloud-based teleconferencing service; and transmitting the first live teleconferencing stream to the cloud-based teleconferencing service via the Internet connection.

In some examples, and in combination with any of the above aspects and examples, the method further includes, while the first peer-to-peer connection is active, recording the second live teleconferencing stream received from the second computing device via the first peer-to-peer connection; and after establishing the Internet connection to the cloud-based teleconferencing service, transmitting a recording of the second live teleconferencing stream to the cloud-based teleconferencing service via the Internet connection.

In some examples, and in combination with any of the above aspects and examples, the method further includes obtaining a second user identifier corresponding to a second invitee of the scheduled teleconferencing session; in response to determining that the cloud-based teleconferencing service is unavailable, transmitting, to the computer system, the second user identifier; receiving, from the computer system, a second IP address associated with the meeting identifier and the second user identifier; initiating a second peer-to-peer connection with a third computing device that corresponds to the second IP address; transmitting, to the third computing device via the second peer-to-peer connection, the first live teleconferencing stream; and receiving, from the third computing device via the first peer-to-peer connection, a third live teleconferencing stream.

In some examples, and in combination with any of the above aspects and examples, the method further includes, while the first peer-to-peer connection and the second peer-to-peer connection are active: recording the second live teleconferencing stream received from the second computing device via the first peer-to-peer connection, and recording the third live teleconferencing stream received from the third computing device via the first peer-to-peer connection; mixing a recording of the second live teleconferencing stream with a recording of the third live teleconferencing stream to generate a composite recording; and after establishing the Internet connection to the cloud-based teleconferencing service, transmitting the composite recording to the cloud-based teleconferencing service via the Internet connection.

In another aspect, the present technology includes a computing device, comprising: at least one processor; and memory, storing instructions that, when executed by the at least one processor, cause the computing device to perform a method. In an example, the method comprises: obtaining a meeting identifier associated with a scheduled teleconferencing session; obtaining a first user identifier corresponding to an invitee of the scheduled teleconferencing session; determining that a cloud-based teleconferencing service associated with the scheduled teleconferencing session is unavailable; in response to determining that the cloud-based teleconferencing service is unavailable, transmitting, to a computer system, the meeting identifier and the first user identifier; receiving, from the computer system, an Internet protocol (IP) address associated with the meeting identifier and the first user identifier; initiating a first peer-to-peer connection with a second computing device that corresponds to the IP address; transmitting, to the second computing device via the first peer-to-peer connection, a first live teleconferencing stream; and receiving, from the second computing device via the first peer-to-peer connection, a second live teleconferencing stream.

In some examples, and in combination with any of the above aspects and examples, the method further includes, after initiating the first peer-to-peer connection with the second computing device, receiving authentication information from the second computing device via the first peer-to-peer connection; and authenticating the second computing device based on the authentication information, wherein transmitting the first live teleconferencing stream to the second computing device is based on authenticating the second computing device.

In some examples, and in combination with any of the above aspects and examples, the method further includes, before detecting that the cloud-based teleconferencing session is unavailable, receiving second authentication information via an Internet connection, wherein authenticating the second computing device comprises determining that the authentication information corresponds to the second authentication information.

In some examples, and in combination with any of the above aspects and examples, the method further includes, before transmitting the first user identifier: establishing an Internet connection to the cloud-based teleconferencing service; and participating in a teleconferencing session with the second computing device via the Internet connection and the cloud-based teleconferencing service, wherein: determining that the cloud-based teleconferencing service is unavailable comprises detecting, during the teleconferencing session with the second computing device, that the Internet connection to the cloud-based teleconferencing service is unavailable, and the first user identifier is transmitted to the computer system based on detecting that the Internet connection to the cloud-based teleconferencing service is unavailable.

In some examples, and in combination with any of the above aspects and examples, determining that the cloud-based teleconferencing service is unavailable comprises determining that an Internet connection to the cloud-based teleconferencing service cannot be established, and the first user identifier is transmitted to the second computing device based on determining that the Internet connection to the cloud-based teleconferencing service cannot be established.

In some examples, and in combination with any of the above aspects and examples, the computer system comprises a domain name system (DNS) server.

In some examples, and in combination with any of the above aspects and examples, the method further includes, before determining that the cloud-based teleconferencing service is unavailable, transmitting, to the computer system, the meeting identifier and a second user identifier corresponding to a user of the first computing device.

In some examples, and in combination with any of the above aspects and examples, the method further includes, while the first peer-to-peer connection is active, determining that the cloud-based teleconferencing service is available; in response to determining that the cloud-based teleconferencing service is available and in accordance with a determination that one or more criteria are satisfied, establishing an Internet connection to the cloud-based teleconferencing service; and transmitting the first live teleconferencing stream to the cloud-based teleconferencing service via the Internet connection.

In some examples, and in combination with any of the above aspects and examples, the method further includes, while the first peer-to-peer connection is active, recording the second live teleconferencing stream received from the second computing device via the first peer-to-peer connection; and after establishing the Internet connection to the cloud-based teleconferencing service, transmitting a recording of the second live teleconferencing stream to the cloud-based teleconferencing service via the Internet connection.

In some examples, and in combination with any of the above aspects and examples, the method further includes obtaining a second user identifier corresponding to a second invitee of the scheduled teleconferencing session; in response to determining that the cloud-based teleconferencing service is unavailable, transmitting, to the computer system, the second user identifier; receiving, from the computer system, a second IP address associated with the meeting identifier and the second user identifier; initiating a second peer-to-peer connection with a third computing device that corresponds to the second IP address; transmitting, to the third computing device via the second peer-to-peer connection, the first live teleconferencing stream; and receiving, from the third computing device via the first peer-to-peer connection, a third live teleconferencing stream.

In some examples, and in combination with any of the above aspects and examples, the method further includes, while the first peer-to-peer connection and the second peer-to-peer connection are active: recording the second live teleconferencing stream received from the second computing device via the first peer-to-peer connection, and recording the third live teleconferencing stream received from the third computing device via the first peer-to-peer connection; mixing a recording of the second live teleconferencing stream with a recording of the third live teleconferencing stream to generate a composite recording; and after establishing the Internet connection to the cloud-based teleconferencing service, transmitting the composite recording to the cloud-based teleconferencing service via the Internet connection.

In an aspect, the present technology includes a method comprising: obtaining a meeting identifier associated with a scheduled teleconferencing session; obtaining a user identifier corresponding to an invitee of the scheduled teleconferencing session; initiating the scheduled teleconferencing session, including establishing an Internet connection to a cloud-based teleconferencing service associated with the scheduled teleconferencing session and transmitting a first live teleconferencing stream to the cloud-based teleconferencing service via the Internet connection; while the teleconferencing session is active, determining that the cloud-based teleconferencing service has become unavailable; in response to determining that the cloud-based teleconferencing service has become unavailable, transmitting, to a domain name system (DNS), the meeting identifier and the user identifier; receiving, from the DNS, an Internet protocol (IP) address associated with the meeting identifier and the user identifier; initiating a peer-to-peer connection with a second computing device that corresponds to the IP address; transmitting, to the second computing device via the peer-to-peer connection, the first live teleconferencing stream; receiving, from the second computing device via the peer-to-peer connection, a second live teleconferencing stream; and presenting the second live teleconferencing stream.

These and other features, aspects and advantages of the examples of the present disclosure will be more fully understood when considered with respect to the following detailed description, appended claims, and accompanying drawings.

### BRIEF DESCRIPTION OF THE DRAWINGS

Non-limiting and non-exhaustive examples of the present embodiments are described with reference to the following figures, wherein like reference numerals refer to like parts throughout the various views unless otherwise specified.

FIG. 1 is a block diagram of an example networking environment for accessing a cloud-based teleconferencing service according to one example;

FIG. 2 is a block diagram of a networking environment for initiating peer-to-peer teleconferencing according to one example;

FIG. 3 is a swimlane diagram of a process for initiating peer-to-peer teleconferencing according to one example;

FIGS. 4A-4B depict a flow diagram of a process for initiating peer-to-peer teleconferencing according to one example; and

FIG. 5 is a block diagram of a computing device according to one example.

### DETAILED DESCRIPTION

Hereinafter, examples will be described in more detail with reference to the accompanying drawings, in which like reference numbers refer to like elements throughout. The present disclosure, however, may be embodied in various different forms, and should not be construed as being limited to only the illustrated examples herein. Rather, these examples are provided so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described. Unless otherwise noted, like reference numerals denote like elements throughout the attached drawings and the written description, and thus, descriptions thereof may not be repeated. Further, in the drawings, the relative sizes of elements, layers, and regions may be exaggerated and/or simplified for clarity.

Teleconferencing services, such as audio- and/or video-conferencing services, are typically hosted on one or more server(s) that are managed by a teleconferencing service provider. In a cloud-based teleconferencing architecture, a client device (e.g., a computing device such as a laptop computer, desktop computer, tablet, cell phone, or other device) requests and receives teleconferencing services from the server(s) via an Internet connection. That is, each participant in a teleconferencing session connects the participant's computing device to the teleconferencing service via an Internet connection and is able to transceive a live (e.g., unrecorded, real-time) teleconferencing stream of audio and/or video with other participants via the Internet connection. In some cases, however, an Internet connection to the teleconferencing service (e.g., to a server associated with the teleconferencing service) cannot be established and/or maintained by a client device as a result of connectivity and/or configuration problems. For example, a participant may not be able to join a teleconferencing session (e.g., a meeting) because the participant's device is unable to establish an Internet connection to the teleconferencing service, or a participant may be dropped from an active teleconferencing session because the Internet connection is severed during the session. In other cases, the one or more servers hosting the teleconferencing session may malfunction or become unreachable. In such cases, it may be desirable for the participants to establish or continue the teleconferencing session using an alternative form of connection.

In general terms, examples of the present disclosure are directed to systems and methods for initiating peer-to-peer teleconferencing in response to a determination that a cloud-based teleconferencing service is unavailable.

In some examples, a first client device (e.g., corresponding to a first participant in a teleconferencing session) detects that a cloud-based teleconferencing service is unavailable and in response, retrieves an IP address of a second client device (e.g., corresponding to a second participant in the teleconferencing session) in preparation for establishing a peer-to-peer connection with the second client device. In some examples, the first client device retrieves the IP address of the second client device from a domain name system (DNS) server based on one or more user identifiers associated with the second participant, such as an email address, telephone number, and/or name. Additionally or alternatively, in some examples, the first client device retrieves the IP address of the second client device from a DNS server based on a meeting identifier associated with a teleconferencing session, such as a meeting name, meeting date, meeting location, and/or meeting time. In some examples, after the first client device obtains the IP address of the second client device, the first client device uses the IP address to initiate a peer-to-peer connection with the second client device, such as by transmitting a connection request to the IP address of the second client device. The first client device and second client device may then establish a peer-to-peer connection and initiate or continue the teleconferencing session.

In some cases, it may be desirable to confirm that the second client device is authorized to participate in the teleconferencing session prior to initiating or continuing the teleconferencing session via the peer-to-peer connection. Thus, in some examples, after establishing the peer-to-peer connection with the second client device, the first client device may perform an authentication procedure to authenticate the second client device prior to initiating (or continuing) the teleconferencing session with the second client device. In some examples, the first client device receives authentication information from the second client device (e.g., via the peer-to-peer connection) and performs an authentication procedure that may include, for example, comparing the authentication information received from the second client device with authentication information previously stored on (or otherwise accessible to) the first client device. In some examples, the first client device initiates or continues the teleconferencing session with the second client device based on successfully authenticating the second client device.

To enable client devices to use DNS records to establish peer-to-peer connections with other client devices as described above, each client device may publish a DNS record to the DNS that includes the IP address of the client device along with one or more user identifiers and/or one or more meeting identifiers that can subsequently be used by another client device to look up the corresponding IP address. For example, a client device may publish a DNS record (e.g., transmit a DNS record to a DNS server to cause the DNS record to be stored in a DNS) when a cloud-based teleconferencing session is initiated so that, if the cloud-based teleconferencing service becomes unreachable by the client (e.g., the client's Internet connection is severed during the session), other client devices can look up the IP address and use it to establish a peer-to-peer connection with the client device and continue the teleconferencing session. Additionally or alternatively, a client device may publish a DNS record as described above at other times (e.g., other than during a cloud-based teleconferencing session) such that the IP address of the client device can subsequently be looked up by other client devices if, e.g., an Internet connection to the teleconferencing server cannot be initially established by one or more of the other client devices. In some examples, the DNS record that is published may comprise an A record, an AAAA record, or other established (or newly defined) DNS record type. In some examples, the DNS record is published programmatically to an authoritative DNS server by a teleconferencing application operating on the client device(s).

Client devices may exchange authentication information during a cloud-based teleconferencing session so that the client devices can subsequently be authenticated via a peer-to-peer connection if the Internet connection is severed. In some examples, a client device can include the authentication information in the DNS record that is transmitted to the DNS. Additionally or alternatively, client devices may receive authentication information at other times (e.g., from other client devices and/or from other sources) and store the authentication information locally, and/or authentication information for a client device may be stored at a centralized location that can subsequently be accessed by another client device to perform authentication.

Additional details regarding systems and methods for initiating peer-to-peer teleconferencing are described with reference to the drawings.

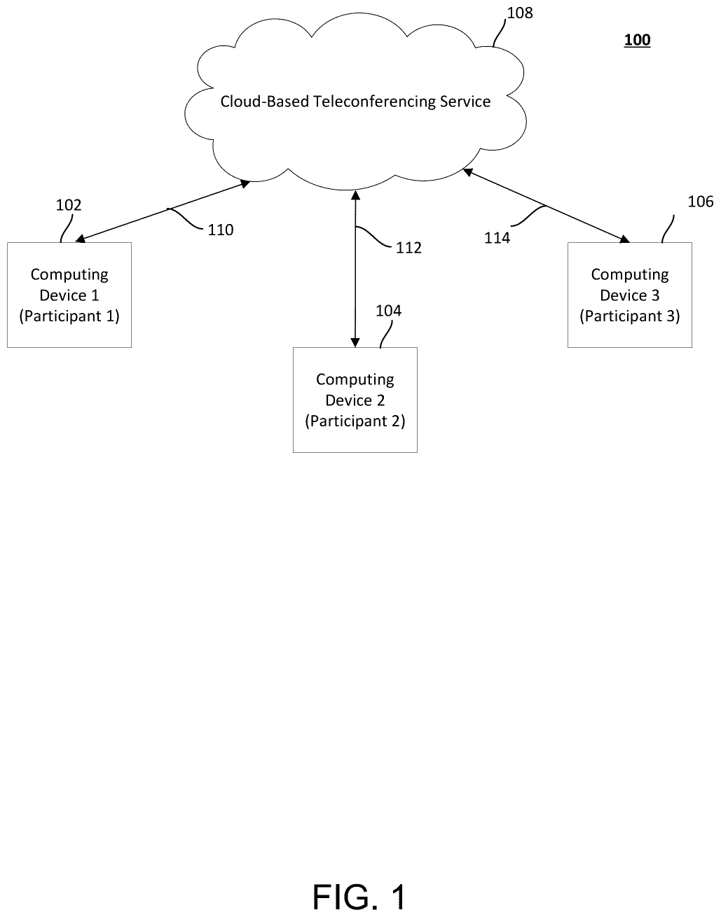

FIG. 1 is a block diagram of an example networking environment 100 that supports cloud-based teleconferencing, according to one example. The networking environment 100 may include any type of telecommunications network that utilizes IP addresses for connecting one or more components of the network.

The example networking environment 100 shown in FIG. 1 includes a first computing device 102 corresponding to a first participant in a scheduled teleconferencing session, a second computing device 104 corresponding to a second participant in the scheduled teleconferencing session, and a third computing device 104 corresponding to a third participant in the scheduled teleconferencing session. The computing devices 102, 104, 106 shown in FIG. 1 may include, for example, laptop computers, desktop computers, smartphones, tablets, or other types of computing devices.

The networking environment shown in FIG. 1 includes a cloud-based teleconferencing service 108 that is configured to provide teleconferencing capabilities between two or more participants, such as by relaying audio, video, and/or other content received from each participant to the other participants. In some examples, the cloud-based teleconferencing service 108 includes one or more servers used to implement the teleconferencing service. In some examples, the cloud-based teleconferencing service 108 is associated with a teleconferencing application that may be installed on the computing devices 102, 104, 106, and the cloud-based teleconferencing service 108 may be accessed, by the computing devices 102, 104, 106, by activating the associated teleconferencing application. Thus, the scheduled teleconferencing session may be associated with the cloud-based teleconferencing service 108.

In the example of FIG. 1, the first computing device 102 is connected to the cloud-based teleconferencing service 108 via a first Internet connection 110. Similarly, the second computing device 104 and third computing device 106 are connected to the cloud-based teleconferencing service 108 via second and third Internet connections 112, 114 (respectively). While a teleconferencing session is active (e.g., in progress), the first computing device 102 may transmit a first live teleconferencing stream to the cloud-based teleconferencing service 108 via the first Internet connection 110. The first live teleconferencing stream transmitted by the first computing device 102 may include, for example, live (e.g., real-time) video and/or audio captured by a camera and/or microphone of the first computing device 102, and/or other content (such as slide decks and/or pre-recorded media) that may be shared by the first computing device 102 and transmitted to the cloud-based teleconferencing session 108. In some examples, the teleconferencing service 108 may receive live teleconferencing streams from each of the computing devices 102, 104, 106 and mix them together (e.g., based on time stamps contained in the teleconferencing streams) to generate a composite teleconferencing stream that is transmitted, via the respective Internet connections 110, 112, 114, to the computing devices 102, 104, 106 (respectively). Computing devices 102, 104, 106 may each display, play, or otherwise present the composite teleconferencing stream to the corresponding participant. In some examples, the cloud-based teleconferencing service 108 stores a recording of the composite teleconferencing stream that can subsequently be accessed (e.g., played and/or downloaded) by the computing devices 102, 104, 106. In some examples, one or more of the computing devices 102, 104, 106 records the composite teleconferencing stream received from the cloud-based teleconferencing service 108 while the teleconferencing session is in progress.

In some examples, a user of a computing device may schedule a teleconferencing session (e.g., a meeting) using a teleconferencing application, such as by inputting one or more of a date, time, or location and/or by selecting one or more additional invitees, such as by entering one or more email addresses, names, job titles, or other user identifiers associated with invitees. In some examples, a teleconferencing session can be scheduled by simply inviting participants (e.g., inputting one or more user identifiers, such as one or more email addresses, names, or other user identifiers) without entering a future time and/or date. That is, a scheduled teleconferencing session need not be associated with a future time and/or date.

In some examples, each computing device 102, 104, 106 initiates an Internet connection 110, 112, 114 to the cloud-based teleconferencing service 108 in response to detecting a selection of a meeting invitation (e.g., by selecting an icon or text associated with the meeting) and/or detecting a request to launch an application associated with the teleconferencing session. For example, a user may select a meeting invitation from an email application, a calendar application, a messaging application, a teleconferencing application, or another application installed on the computing device 102, 104, 106. In some examples, the meeting invitation is associated with one or more meeting identifiers, such as a meeting title, date, time, location, and/or other meeting identifier. In some examples, a meeting invitation is associated with one or more user identifiers corresponding to one or more invitees of the meeting. Such user identifiers may include, for example, email addresses, names, job titles, or other user identifiers.

In some cases, a computing device 102, 104, 106 may be unable to establish an Internet connection with the cloud-based teleconferencing session 108 to initiate a teleconferencing session (e.g., to launch the meeting) due to, for example, connectivity or configuration problems or because the cloud-based teleconferencing service 108 is not operating properly. In some cases, a computing device 102, 104, 106 may initially establish an Internet connection with the cloud-based teleconferencing service 108 and the Internet connection may subsequently be severed during the teleconferencing session or the cloud-based teleconferencing service 108 may become temporarily inoperable. Either scenario may cause the teleconferencing session to be interrupted or terminated.

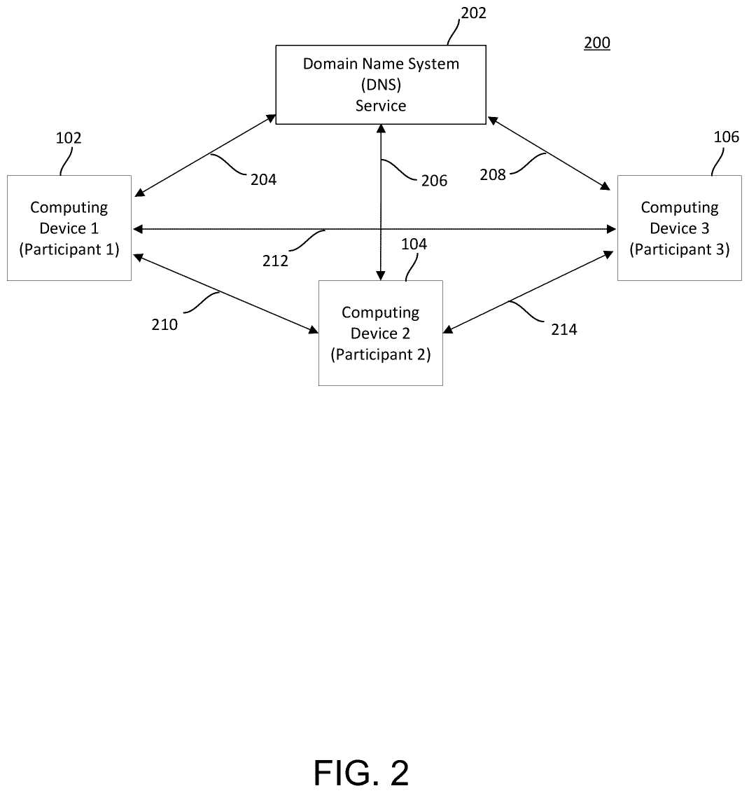

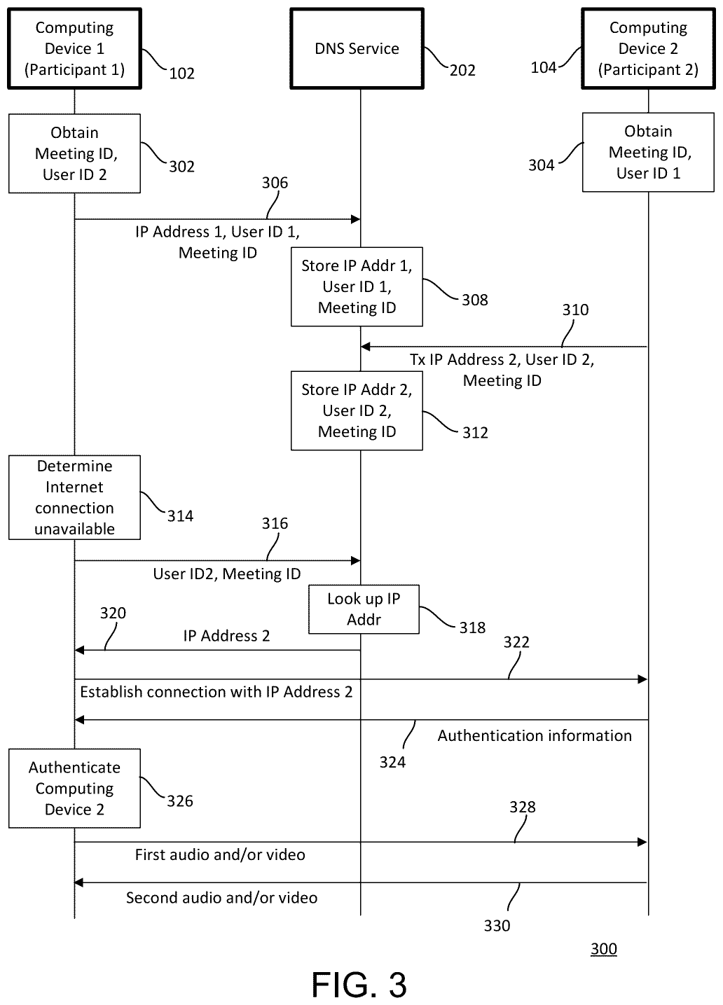

As described with reference to FIGS. 2-3, in response to determining that the cloud-based teleconferencing service is unavailable (e.g., either an Internet connection to the cloud-based teleconferencing service cannot be initially established or an active teleconferencing session has been terminated due to problems with the Internet connection or with the cloud-based teleconferencing service itself), a computing device 102, 104, 106 may obtain the IP addresses of one or more other computing devices 102, 104, 106 (e.g., corresponding to other invitees or participants in the meeting), establish peer-to-peer connections with the other computing devices 102, 104, 106, and participate in the teleconferencing session via the peer-to-peer connections.

Although the example of FIG. 1 depicts three computing devices 102, 104, 106, it should be understood that there may be a different number of computing devices participating in a teleconferencing session, such as two, four, or any other plurality.

FIG. 2 is a block diagram of an example networking environment 200 that supports initiation of peer-to-peer teleconferencing, according to one example. The networking environment 200 may include any type of telecommunications network that utilizes IP addresses for connecting one or more components of the network.

Networking environment 200 includes computing device 102, computing device 104, and computing device 106 as described with reference to FIG. 1. Networking environment 200 includes domain name system (DNS) 202, which may include a hierarchy of DNS caching/recursive and authoritative servers and associated databases and other storage, for storing IP addresses along with one or more identifiers (e.g., a domain name, such as a domain name of a teleconferencing service, one or more user identifiers, one or more meeting identifiers, and/or other types of identifiers) associated with the IP address.

In response to determining that a cloud-based teleconferencing service is unavailable (e.g., due to the unavailability of an Internet connection 110, 112, and/or 114 to cloud-based teleconferencing service 108 or unavailability of the cloud-based teleconferencing service itself, as described with reference to FIG. 1), a computing device 102, 104, 106 may query a DNS service 202 to determine the IP addresses of the other computing devices 102, 104, 106 (e.g., other invitees or participants in the teleconferencing session). For example, a first computing device 102 may transmit, to DNS service 202 via Internet connection 204, a request for an IP address of a computing device 104 associated with another participant (e.g., invitee) in the teleconferencing session, where the request includes one or more user identifiers corresponding to the participant and/or one or more meeting identifiers associated with the teleconferencing session. The request may take the form of a DNS query for a particular type of DNS record, such as an A record, an AAAA record, or another type of established or newly defined DNS record for the purpose of returning the IP address(es) of the other participant(s) in the teleconferencing session.

In response to receiving the request from the first computing device 102, the DNS service 202 looks up the IP address of computing device 104 based on the identifiers including in the request and transmits the IP address of computing device 104 to the requesting computing device 102 via Internet connection 204. In some examples, the requested DNS records may be returned by a caching/recursive DNS server of DNS service 202 (if available in the caching/recursive DNS server's cache), or may be returned after a recursive series of queries to, e.g., authoritative DNS server(s). In some examples, information available to the requesting computing device 102 about other participants in the meeting may be used to construct the DNS query. For example, the DNS query may be constructed to include one or more of another participant's email address, the meeting identifier, or other information. Such information used in the query may be retrieved, In some examples, from a meeting request of a scheduled meeting, stored in a calendar application that is used in conjunction with a teleconferencing application, or otherwise. After computing device 102 receives the IP address of computing device 104, computing device 102 may establish a peer-to-peer connection 210 with computing device 104 and begin transmitting and/or receiving teleconferencing data to/from computing device 104.

More generally, each computing device 102, 104, 106 can obtain an IP address associated with another participant (e.g., a user of another computing device 102, 104, 106) from DNS service 202 as described above, using corresponding Internet connections 204, 206, 208 to DNS service 202. After receiving the IP address(es) of the other participant(s), each computing device 102, 104, 106 may establish peer-to-peer connections 210, 212, 214 with computing devices 102, 104, 106 of the other participants and begin (or continue) the teleconferencing session using the peer-to-peer connections 210, 212, 214. A peer-to-peer connection is generally understood to be a connection (e.g., a wired or wireless communication path) between two computing devices that enables the devices to share data and/or tasks directly without the use of a separate server or separate centralized computing system. In some examples, either device can initiate a peer-to-peer connection with the other device, and the devices may cooperate (e.g., through a plurality of handshake operations) to negotiate and establish a peer-to-peer connection through one or more agreed upon peering protocols.

In some examples, after establishing peer-to-peer connections, one or more of the computing devices 102, 104, 106 may perform one or more authentication procedures to authenticate one or more of the other computing device devices 102, 104, 106 before initiating (or continuing) the teleconference session with the other computing device devices 102, 104, 106. This process is illustrated in more detail in the swimlane diagram of FIG. 3.

In some examples, after establishing a peer-to-peer connection with one or more other computing devices 102, 104, 106 and while participating in a teleconferencing session via the peer-to-peer connections, a computing device 102, 104, 106 may determine, continuously, periodically, or at discrete times, whether the cloud-based teleconferencing service is (e.g., has become) available. In some examples, in response to determining that an Internet connection to the cloud-based teleconferencing service is available, the computing device 102, 104, 106 establishes the Internet connection to the cloud-based teleconferencing service and continues the teleconferencing session via the Internet connection using the cloud-based teleconferencing service (such as depicted in FIG. 1). In some examples, after (e.g., in response to) establishing the Internet connection to the cloud-based teleconferencing service, the computing device 102, 104, 106 ceases to transmit a live teleconferencing stream to the other computing devices via the peer-to-peer connection(s); for example, the computing device may switch from peer-to-peer teleconferencing to cloud-based teleconferencing.

In some examples, when and/or after the computing device determines that an Internet connection to the cloud-based teleconferencing service is available, additional criteria must be satisfied before the computing device 102, 104, 106 establishes the Internet connection to the cloud-based teleconferencing service and/or before the computing device initiates or continues the teleconferencing session. Such criteria may include, for example, a criterion that is satisfied when the Internet connection to the cloud-based teleconferencing session has been available for at least a threshold time duration (e.g., 1, 5, 10, 30, 60, 120, or 360 seconds), a criterion that is satisfied when the computing device determines that the Internet connection to the cloud-based teleconferencing session provides a minimum bandwidth, and/or a criterion that is satisfied when the computing device determines that one or more other computing devices (e.g., corresponding to one or more other participants) have established (or can establish) respective Internet connections to the cloud-based teleconferencing service. For example, a criterion might be satisfied only when all peer-to-peer participants signal each other that they have determined an Internet connection to the cloud-based teleconferencing service is available. Such criteria may help to avoid frequent and/or disruptive switching between the use of a peer-to-peer connection for teleconferencing and the use of an Internet connection to a cloud-based teleconferencing service.

In some examples, while the peer-to-peer teleconferencing session is active, one or more of the computing devices may record live teleconferencing stream(s) received from one or more other computing devices and/or transmitted by the recording computing device. For example, the first computing device 102 may record a first live teleconferencing stream transmitted by the first computing device 102, a second teleconferencing stream received from the second computing device 104, and/or a third live teleconferencing stream received from the third computing device 106. In some examples, the first computing device 102 merges two or more recordings (e.g., corresponding to two or more live teleconferencing streams associated with two or more computing devices) into a single composite recording, such as using timestamp information contained in the recorded teleconferencing streams.

In some examples, in response to establishing an Internet connection to a cloud-based teleconferencing service after participating in a peer-to-peer teleconferencing session, the first computing device 102 uploads (e.g., transmits) the one or more recordings of the one or more teleconferencing streams (which may be, for example, multiple separate recordings or a single composite recording) to the cloud-based teleconferencing service. Similarly, other participant client devices 104, 106 may upload the stream(s) that either has recorded during the peer-to-peer teleconferencing session. In some examples, the cloud-based teleconferencing service may then generate a composite recording so that, if later accessed, the composite recording of the call is available for playback.

FIG. 3 is a swimlane diagram of a process 300 for initiating peer-to-peer teleconferencing according to one example. In some examples, operations depicted in FIG. 3 may be performed in a different order than depicted in process 300 and/or may overlap in time. Although FIG. 3 depicts two computing devices 102, 104, it should be understood that similar concepts apply to the case when there are a larger number of computing devices associated with a teleconferencing session (e.g., corresponding to participants or invitees).

At 302, the first computing device 102 (e.g., associated with a first participant in a scheduled teleconferencing session) may obtain a meeting identifier associated with the scheduled teleconferencing session and a user identifier associated with a second participant in the scheduled teleconferencing session (e.g., a user of second computing device 104). For example, the first computing device 102 may obtain (e.g., retrieve, receive) the meeting identifier and/or the user identifier associated with the second participant based on an electronic meeting invitation received by the first computing device 102 and/or based on other information received by the first computing device 102.

Similarly, at 304, a second computing device 104 (e.g., associated with a second participant in the scheduled teleconferencing session) may obtain a meeting identifier associated with the scheduled teleconferencing session (which may be the same meeting identifier obtained by the first computing device 102) and a user identifier associated with the first participant in the scheduled teleconferencing session (e.g., the user of first computing device 102).

At 306, the first computing device 102 may transmit a record to DNS service 202 (e.g., via Internet connection 204 described with reference to FIG. 2), where the record includes a first IP address associated with the first computing device 102, the user identifier associated with the first participant (e.g., User ID 1 shown in FIG. 3), and the meeting identifier. In some examples, the record includes authentication information associated with the first participant, such as a hash, password, or other authentication information. In some examples, the record comprises an A record, an AAAA record, or another type of established or newly defined DNS record for the purpose of making the IP address of first computing device 102 available to other participant(s) in a teleconferencing session.

At 308, the DNS service 202 may store (e.g., in one or more DNS databases or related DNS storage) the record received from the first computing device 102.

At 310, the second computing device 104 may transmit a record to DNS service 202 (e.g., via Internet connection 206 described with reference to FIG. 2), where the record includes a second IP address associated with the second computing device 104, the user identifier associated with the second participant (e.g., User ID 2 shown in FIG. 3), and the meeting identifier. In some examples, the record includes authentication information associated with the second participant, such as a hash, password, or other authentication information.

At 312, the DNS service 202 may store (e.g., in one or more DNS databases or related DNS storage) the record received from the second computing device 104.

At 314, the first computing device 102 may determine that a cloud-based teleconferencing service (e.g., cloud-based teleconferencing service 108 described with reference to FIG. 1) is unavailable. In the depicted example, the first computing device 102 determines that the cloud-based teleconferencing service is unavailable by detecting that an Internet connection to the cloud-based teleconferencing service is unavailable. In some examples, the first computing device 102 determines that the cloud-based teleconferencing session is unavailable after the teleconferencing session has already been initiated with the cloud-based teleconferencing service via the Internet connection; e.g., the first computing device 102 detects that the Internet connection has become unavailable during an active teleconferencing session. In some examples, the first computing device 102 determines that the cloud-based teleconferencing session is unavailable at the time when the first computing device 102 attempts to establish an Internet connection to the cloud-based teleconferencing service; e.g., before the teleconferencing session has begun. In some examples, the second computing device 104 may also determine that an Internet connection to the cloud-based teleconferencing session is unavailable.

At 316, in response to determining that the cloud-based teleconferencing service is unavailable, the first computing device 102 transmits, to the DNS service 202, the user identifier associated with the second participant (e.g., User ID 2) and/or the meeting identifier. In some cases, the user identifier and/or meeting identifier are transmitted in a DNS query that incorporates the user identifier and/or meeting identifier into the DNS query (e.g., a request for an AAAA record associated with the second computing device 104 and/or the meeting identifier).

At 318, the DNS service 202 uses the meeting identifier and/or the user identifier associated with the second participant to look up (e.g., retrieve from a DNS database or related storage) an IP address corresponding to (e.g., based on) the user identifier and/or the meeting identifier. In some examples, the lookup comprises identifying the DNS record stored at operation 312.

At 320, the DNS service 202 transmits the retrieved IP address (e.g., IP address 2, corresponding to the second computing device 104 associated with the second participant) to the first computing device 102. In some examples, the DNS service 202 also transmits, to the first computing device 102, authentication information (e.g., associated with the second participant) that may be stored with the IP address in the DNS record. In some examples, operation 320 comprises transmitting, by the DNS service 202 to the first computing device 102, the DNS record stored at operation 312.

At 322, the first computing device 102 establishes a peer-to-peer connection with the second computing device 104 using the IP address (IP Address 2) received from the DNS service 202. For example, the first computing device 102 may transmit a connection request to the second computing device 104, receive a connection confirmation from the second computing device 104, and/or perform a handshake procedure to establish the peer-to-peer connection.

In some examples, at 324, the second computing device 104 transmits authentication information to the first computing device 102. The authentication information may include, for example, a password, hash, or other type of information that has previously been provided to the first computing device 102 and can be used to authenticate the second computing device 104. Such authentication may be desirable, for example, to avoid allowing an unauthorized participant into a teleconferencing session.

In some examples, at 326, the first computing device 102 performs an authentication procedure to authenticate the second computing device 104 using the authentication information received from the second computing device 104. For example, the first computing device 102 may compare the authentication information received from the second computing device 104 to second authentication information that was previously received by the first computing device 102 and stored on the first computing device 102. The second authentication information may have been previously received from the second computing device 104 (e.g., during a teleconferencing session that was interrupted) or from another source (e.g., a company may distribute the same authentication information to its employees). In some examples, the second authentication information is received by the first computing device 102 from DNS service 202 (e.g., at 320). In some examples, the second authentication information may be retrieved by the first computing device 102 from an external source, such as a company website or authentication service, prior to or during the authentication procedure.

If the authentication procedure performed at 326 is successful (or alternatively, if it is not required), at 328, the first computing device 102 may initiate the teleconferencing session (or continue the teleconferencing session, if the teleconferencing session was previously initiated using the cloud-based teleconferencing service) by transmitting, via the peer-to-peer connection, a first live teleconferencing stream to the second computing device 104, such as by transmitting live video, audio, or other content captured or shared by the first computing device 102.

Similarly, at 330, the second computing device 104 may transmit, via the peer-to-peer connection, a second live teleconferencing stream to the first computing device 102, such as by transmitting live video, audio, or other content captured or shared by the second computing device 104. In some examples, the first computing device 102 presents the second live teleconferencing stream (e.g., by displaying video and/or playing audio of the teleconferencing stream) to the first participant as it is received from the second computing device 104.

In some examples, before initiating or continuing the teleconferencing session (e.g., before transmitting the second live teleconferencing stream), the second computing device 104 may receive authentication information from the first computing device 102 and perform an authentication procedure to authenticate the first computing device 102 in a manner similar to that described above with respect to authenticating the second computing device 104. The second computing device 104 may transmit the second live teleconferencing stream based on successfully authenticating the first computing device 102. For example, each computing device 102, 104 may authenticate the other computing device 102, 104 prior to initiating or continuing a teleconferencing session via a peer-to-peer connection.

In some examples, one or both of the computing devices 102, 104 may record one or more live teleconferencing streams and may subsequently transmit one or more recordings of the one or more live teleconferencing streams to a cloud-based teleconferencing service via an Internet connection, such as described with reference to FIG. 2. In some examples, certain teleconferencing features that are available during a cloud-based teleconference are disabled during the time that the teleconference is switched to a peer-to-peer teleconference. For example, screen sharing may be disabled. In other examples, if a participant opts to share a screen during the peer-to-peer teleconference, the images associated with the screen that is being shared may be transmitted as part of that participant's outgoing video stream and may be recorded by one or more of that participant's computing device or one of the other participants' computing devices.

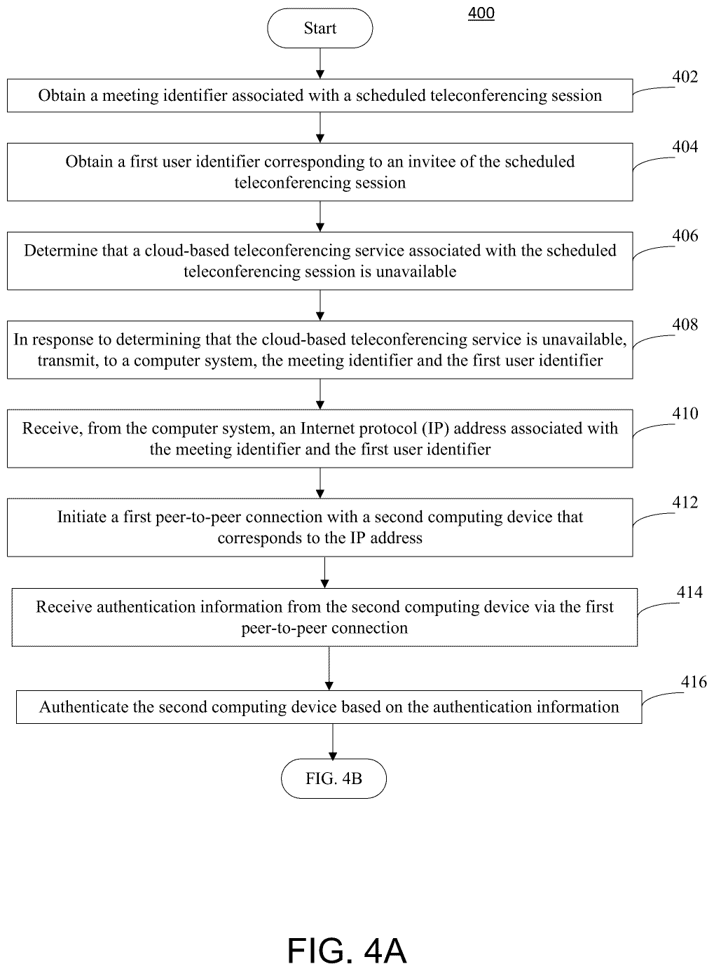

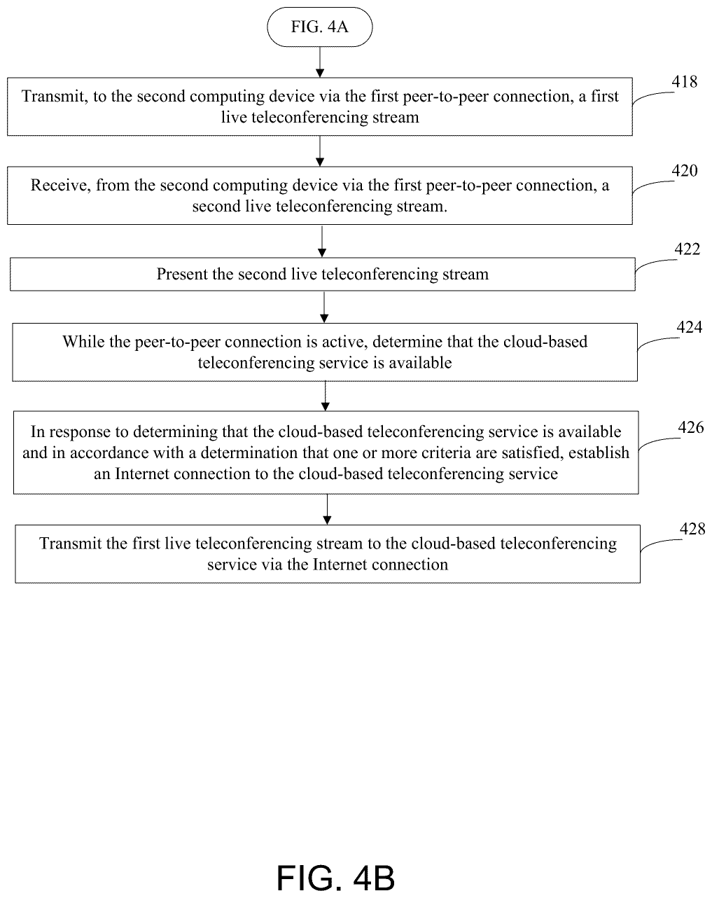

FIGS. 4A-4B depict a flow diagram of a process 400 for initiating peer-to-peer teleconferencing according to one example. In some examples, some or all of the operations of the process 400 may be performed by a first computing device, such as first computing device 102. It should be understood that the sequence of operations of the process is not fixed, but can be modified, changed in order, performed differently, performed sequentially, concurrently, or simultaneously, or altered into any desired sequence, as recognized by a person of skill in the art. In some examples, certain operations depicted in the process 400 may be omitted, and in certain examples, other operations may be added.

The process starts, and at 402, a first computing device (e.g., first computing device 102) obtains a meeting identifier associated with a scheduled teleconferencing session, such as described with reference to FIGS. 2-3. For example, the first computing device may obtain the meeting identifier based on an electronic meeting invitation received by the first computing device (e.g., from another electronic device) or based on other information received by the first computing device.

At 404, a first user identifier corresponding to an invitee of the scheduled teleconferencing session is obtained by the first computing device, such as described with reference to FIGS. 2-3. For example, the first computing device may obtain the first user identifier based on an electronic meeting invitation received by the first computing device (e.g., from another electronic device) or based on other information received by the first computing device. In some examples, the first user identifier corresponds to a user of a second computing device, such as second computing device 104.

At 406, the first computing device determines that a cloud-based teleconferencing service associated with the scheduled teleconferencing session is unavailable, such as described with reference to FIGS. 1-3. For example, the first computing device may determine that an Internet connection to the cloud-based teleconferencing service associated with the scheduled teleconferencing session is unavailable, or that the cloud-based teleconferencing service itself is unavailable.

In some examples, before determining that the cloud-based teleconferencing service is unavailable, the first computing device establishes an Internet connection to the cloud-based teleconferencing service and participates in a teleconferencing session with the second computing device via the Internet connection and the cloud-based teleconferencing service, such as depicted in FIG. 1. In this case, the first computing device may determine that the cloud-based teleconferencing service is unavailable by detecting, during the teleconferencing session with the second computing device, that the Internet connection to the cloud-based teleconferencing service is unavailable (e.g., detecting that the Internet connection has been severed during an active teleconferencing session). In some examples, the first computing device transmits the first user identifier to the computer system based on detecting that the Internet connection to the cloud-based teleconferencing session is unavailable. Such a scenario may occur, for example, when the first computing device loses a previously established connection to the cloud-based teleconferencing service during an active teleconferencing session, in which case the first computing device may request, from a DNS service, the IP address of one or more other invitees of the teleconferencing session.

In some examples, before (or in response to) determining that the cloud-based teleconferencing service is unavailable, the first computing device may publish, to a DNS service such as DNS service 202, a DNS record that comprises an IP address for the first computing device, the meeting identifier obtained at 402, and/or a user identifier corresponding to the user of the first computing device. For example, the first computing device may publish the DNS record to the DNS service via an Internet connection. For example, the first computing device may publish a record to the DNS service that includes information that will enable other invitees of the teleconferencing session to locate and connect with the first computing device if the cloud-based teleconferencing session is unavailable.

At 408, in response to determining that the cloud-based teleconferencing service is unavailable, the first computing device transmits, to a computer system (e.g., a computer system that comprises a DNS server, such as DNS service 202), information about the meeting and/or the user of the second computing device. For example, the information may include the meeting identifier and/or the first user identifier, such as described with reference to FIGS. 2-3. As previously discussed, in some examples, the information may be communicated to the DNS service 202 in a request for a DNS record, such as an A record or AAAA record.

At 410, the first computing device receives, from the computer system, an Internet protocol (IP) address associated with the meeting identifier and the first user identifier, such as described with reference to FIGS. 2-3. For example, the first computing device receives the IP address in response to (e.g., after) transmitting the meeting identifier and the first user identifier. As previously discussed, in some examples, the IP address may be communicated to the first computing device as part of a DNS record, such as an A record or an AAAA record.

At 412, the first computing device initiates a first peer-to-peer connection (e.g., peer-to-peer connection 210) with a second computing device (e.g., second computing device 104) that corresponds to the IP address received at operation 412, such as described with reference to FIGS. 2-3.

At 414, the first computing device receives, from the second computing device via the peer-to-peer connection, authentication information, such as described with reference to FIGS. 2-3.

At 416, the first computing device authenticates the second computing device based on the authentication information, such as described with reference to FIG. 3. In some examples, the first computing device receives second authentication information before determining that the cloud-based teleconferencing service is unavailable (e.g., via an Internet connection, such as an Internet connection to the cloud-based teleconferencing service), and authenticates the second computing device by determining that the authentication information received from the second computing device via the peer-to-peer connection corresponds to the second authentication information (e.g., the authentication information matches the second authentication information, has the same hash value as the second authentication information, or can otherwise be used to confirm the authenticity of the second computing device and/or of a user of the second computing device).

At 418, the first computing device transmits, to the second computing device via the first peer-to-peer connection, a first live teleconferencing stream, such as described with reference to FIGS. 2-3. In some examples, the first computing device transmits the first live teleconferencing stream to the second computing device based on (e.g., in response to, after) authenticating the second computing device at 416. In some examples, if the first computing device is unable to authenticate the second computing device, the first computing device refrains from transmitting the first live teleconferencing stream to the second computing device. As previously discussed, in some examples, the first live teleconferencing stream includes live audio and/or video captured by a camera and/or microphone of the first computing device and may include additional content that is presented or shared by the first computing device (such as a slide deck, recorded video clip, electronic document, or other type of content).

At 420, the first computing device receives, from the second computing device via the first peer-to-peer connection, a second live teleconferencing stream, such as described with reference to FIGS. 2-3. In some examples, the second live teleconferencing stream includes live audio and/or video captured by a camera and/or microphone of the second computing device and may include additional content that is presented or shared by the second computing device.

In some examples, while the first peer-to-peer connection is active, the first computing device records the second live teleconferencing stream (e.g., the teleconferencing stream received from the second computing device).

At 422, the first computing device presents the second live teleconferencing stream, such as by causing the display of video content of the second live teleconferencing stream on a display associated with (e.g., included in or connected to) the first computing device, causing the playing of audio content of the second live teleconferencing stream via a speaker associated with the first computing device, or otherwise making content of the second live teleconferencing stream visible or audible to a user of the first computing device.

At 424, while the peer-to-peer connection is active (e.g., while the first computing device is participating in a teleconferencing session with the second computing device via the peer-to-peer connection), the first computing device determines that the cloud-based teleconferencing service is (e.g., has become) available, such as described with reference to FIG. 2.

At 426, in response to determining that the cloud-based teleconferencing service is available and in accordance with a determination that one or more criteria are satisfied (e.g., such as the criteria described with reference to FIG. 2), the first computing device establishes an Internet connection to the cloud-based teleconferencing service.

At 428, the first computing device transmits the first live teleconferencing stream to the cloud-based teleconferencing service via the Internet connection, thereby continuing the teleconferencing session using the Internet connection and the cloud-based teleconferencing service as described with reference to FIG. 1.

In some examples, after establishing an Internet connection to the cloud-based teleconferencing session, the first computing device transmits a recording of the second live teleconferencing stream (e.g., recorded while receiving the second live teleconferencing stream at operation 420) to the cloud-based teleconferencing service via the Internet connection.

In some examples, the first computing device may establish a second peer-to-peer connection (e.g., peer-to-peer connection 212) with a third computing device (e.g., computing device 106, which may be a computing device of another invitee of the teleconferencing session) in a manner similar to that described with respect to the second computing device in operations 408-422 such that the first computing device, the second computing device, and the third computing device can participate in a scheduled teleconferencing session via respective peer-to-peer connections as depicted in FIG. 2.

For example, the first computing device may obtain a second user identifier corresponding to a second invitee of the scheduled teleconferencing session, and in response to determining that the cloud-based teleconferencing service is unavailable (e.g., at operation 406), transmit, to the computer system (e.g., DNS service 202), the second user identifier. The first computing device may receive, from the computer system, a second IP address associated with the meeting identifier and the second user identifier in a manner similar to that described at operation 410. The first computer system may initiate a second peer-to-peer connection (e.g., peer-to-peer connection 212) with a third computing device (e.g., computing device 106) that corresponds to the second IP address. The first computing device may transmit, to the third computing device via the second peer-to-peer connection, the first live teleconferencing stream (e.g., in a manner similar to that described at operation 418), and receive, from the third computing device via the first peer-to-peer connection, a third live teleconferencing stream (e.g., in a manner similar to that described at operation 420).

In some examples, while the first peer-to-peer connection (e.g., peer-to-peer connection 210) and the second peer-to-peer connection (e.g., peer-to-peer connection 212) are active, the first computing device may record the second live teleconferencing stream received from the second computing device via the first peer-to-peer connection, and record the third live teleconferencing stream received from the third computing device via the first peer-to-peer connection, such as described with reference to operation 420.

In some examples, the first computer system may mix (e.g., combine) a recording of the second live teleconferencing stream with a recording of the third live teleconferencing stream to generate a composite recording, and after establishing the Internet connection to the cloud-based teleconferencing service (e.g., as described at operation 426), transmit the composite recording to the cloud-based teleconferencing service via the Internet connection.

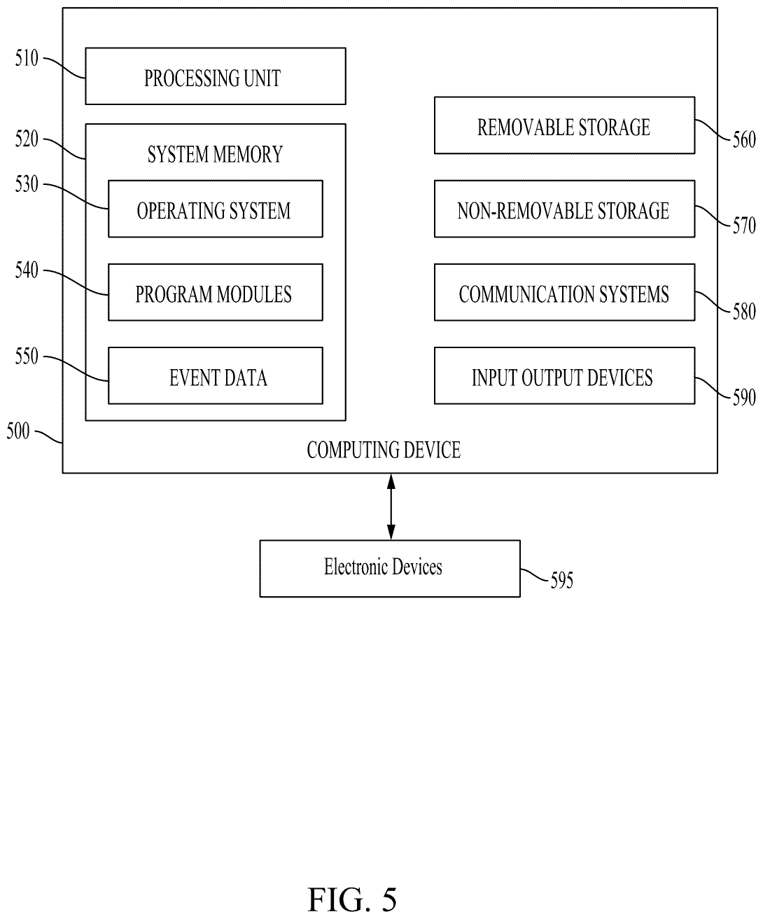

FIG. 5 is a block diagram of a computing device 500 according to an example. The computing device 500, or various components and system of the computing device 500, may be an example of a computing device described with reference to FIGS. 1-3, such as computing device 102, 104, 106. As shown in FIG. 5, the physical components (e.g., hardware) of the computing device 500 are illustrated and these physical components may be used to practice the various aspects of the present disclosure.

The computing device 500 may include at least one processing unit 510 (e.g., a processor and/or other type of processing circuitry) and a system memory 520. The system memory 520 may include, but is not limited to, volatile storage (e.g., random access memory), non-volatile storage (e.g., read-only memory), flash memory, or any combination of such memories. The system memory 520 may also include an operating system 530 that controls the operation of the computing device 500 and one or more program modules 540. The program modules 540 may be responsible for initiating a peer-to-peer teleconferencing session according to the various examples of the present disclosure. A number of different program modules and data files may be stored in the system memory 520. While executing on the processing unit 510, the program modules 540 may perform the various processes described above.

The computing device 500 may also have additional features or functionality. For example, the computing device 500 may include additional data storage devices (e.g., removable and/or non-removable storage devices) such as, for example, magnetic disks, optical disks, or tape. These additional storage devices are labeled as a removable storage 560 and a non-removable storage 570.

Examples of the disclosure may also be practiced in an electrical circuit comprising discrete electronic elements, packaged or integrated electronic chips containing logic gates, a circuit utilizing a microprocessor, or on a single chip containing electronic elements or microprocessors. For example, examples of the disclosure may be practiced via a system-on-a-chip (SOC) where each or many of the components illustrated in FIG. 5 may be integrated onto a single integrated circuit. Such a SOC device may include one or more processing units, graphics units, communications units, system virtualization units and various application functionality all of which are integrated (or “burned”) onto the chip substrate as a single integrated circuit.

When operating via a SOC, the functionality, described herein, may be operated via application-specific logic integrated with other components of the computing device 500 on the single integrated circuit (chip). The disclosure may also be practiced using other technologies capable of performing logical operations such as, for example, AND, OR, and NOT, including but not limited to mechanical, optical, fluidic, and quantum technologies.

The computing device 500 may include one or more communication systems 580 that enable the computing device 500 to communicate with other electronic devices 595 such as, for example, servers, routers, network devices, other computing devices, etc. Examples of communication systems 580 include, but are not limited to, wireless communications systems, wired communications systems, cellular communications systems, radio frequency (RF) transmitter, receiver, and/or transceiver circuitry, a Controller Area Network (CAN) bus, a universal serial bus (USB), parallel, serial ports, etc.

The computing device 500 may also have one or more input devices and/or one or more output devices shown as input/output devices 590. These input/output devices 590 may include a keyboard, a sound or voice input device, haptic devices, a touch, force and/or swipe input device, a display, speakers, etc. The aforementioned devices are examples and others may be used.

The term computer-readable media as used herein may include non-transitory computer storage media. Computer storage media may include volatile and nonvolatile, removable and non-removable media implemented in any method or technology for storage of information, such as computer readable instructions, data structures, or program modules.

The system memory 520, the removable storage 560, and the non-removable storage 570 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 500. Any such computer storage media may be part of the computing device 500. Computer storage media may be tangible and non-transitory and does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

The terminology used herein is for the purpose of describing particular examples only and is not intended to be limiting of the inventive concept. Also, unless explicitly stated, the embodiments described herein are not mutually exclusive. Aspects of the embodiments described herein may be combined in some implementations.

As used herein, the singular forms “a” and “an” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Further, the use of “may” when describing examples of the inventive concept refers to “one or more embodiments of the present disclosure.” Also, the term “exemplary” is intended to refer to an example or illustration. As used herein, the terms “use,” “using,” and “used” may be considered synonymous with the terms “utilize,” “utilizing,” and “utilized,” respectively.

As will be apparent to those of skill in the art, examples of the present systems and methods have multiple technical effects, including enabling the initiation or continuation of a teleconferencing session when a cloud-based teleconferencing service is unavailable, among other advantages.

Although exemplary embodiments of systems and methods for initiating a peer-to-peer teleconferencing session have been specifically described and illustrated herein, many modifications and variations will be apparent to those skilled in the art. Accordingly, it is to be understood that the systems and methods for initiating a peer-to-peer teleconferencing session constructed according to principles of this disclosure may be embodied other than as specifically described herein. The disclosure is also defined in the following claims, and equivalents thereof.

What is claimed is:

1. A method performed at a first computing device, the method comprising:
obtaining a meeting identifier associated with a scheduled teleconferencing session;
obtaining a first user identifier corresponding to an invitee of the scheduled teleconferencing session;
determining that a cloud-based teleconferencing service associated with the scheduled teleconferencing session is unavailable;
in response to determining that the cloud-based teleconferencing service is unavailable, transmitting, to a computer system, the meeting identifier and the first user identifier;
receiving, from the computer system, an Internet protocol (IP) address associated with the meeting identifier and the first user identifier;
initiating a first peer-to-peer connection with a second computing device that corresponds to the IP address;
transmitting, to the second computing device via the first peer-to-peer connection, a first live teleconferencing stream; and
receiving, from the second computing device via the first peer-to-peer connection, a second live teleconferencing stream.

2. The method of claim 1, further comprising:
after initiating the first peer-to-peer connection with the second computing device, receiving authentication information from the second computing device via the first peer-to-peer connection; and
authenticating the second computing device based on the authentication information, wherein transmitting the first live teleconferencing stream to the second computing device is based on authenticating the second computing device.

3. The method of claim 2, further comprising:
before detecting that the cloud-based teleconferencing session is unavailable, receiving second authentication information via an Internet connection, wherein authenticating the second computing device comprises determining that the authentication information corresponds to the second authentication information.

4. The method of claim 1, further comprising:
before transmitting the first user identifier:
establishing an Internet connection to the cloud-based teleconferencing service; and
participating in a teleconferencing session with the second computing device via the Internet connection and the cloud-based teleconferencing service, wherein:
determining that the cloud-based teleconferencing service is unavailable comprises detecting, during the teleconferencing session with the second computing device, that the Internet connection to the cloud-based teleconferencing service is unavailable, and
the first user identifier is transmitted to the computer system based on detecting that the Internet connection to the cloud-based teleconferencing service is unavailable.

5. The method of claim 1, wherein determining that the cloud-based teleconferencing service is unavailable comprises determining that an Internet connection to the cloud-based teleconferencing service cannot be established, and wherein the first user identifier is transmitted to the second computing device based on determining that the Internet connection to the cloud-based teleconferencing service cannot be established.

6. The method of claim 1, wherein the computer system comprises a domain name system (DNS) server.

7. The method of claim 1, further comprising:
before determining that the cloud-based teleconferencing service is unavailable, transmitting, to the computer system, the meeting identifier and a second user identifier corresponding to a user of the first computing device.

8. The method of claim 1, further comprising:
while the first peer-to-peer connection is active, determining that the cloud-based teleconferencing service is available;
in response to determining that the cloud-based teleconferencing service is available and in accordance with a determination that one or more criteria are satisfied, establishing an Internet connection to the cloud-based teleconferencing service; and
transmitting the first live teleconferencing stream to the cloud-based teleconferencing service via the Internet connection.

9. The method of claim 8, further comprising:
while the first peer-to-peer connection is active, recording the second live teleconferencing stream received from the second computing device via the first peer-to-peer connection; and
after establishing the Internet connection to the cloud-based teleconferencing service, transmitting a recording of the second live teleconferencing stream to the cloud-based teleconferencing service via the Internet connection.

10. The method of claim 1, further comprising:
obtaining a second user identifier corresponding to a second invitee of the scheduled teleconferencing session;
in response to determining that the cloud-based teleconferencing service is unavailable, transmitting, to the computer system, the second user identifier;
receiving, from the computer system, a second IP address associated with the meeting identifier and the second user identifier;
initiating a second peer-to-peer connection with a third computing device that corresponds to the second IP address;
transmitting, to the third computing device via the second peer-to-peer connection, the first live teleconferencing stream; and
receiving, from the third computing device via the first peer-to-peer connection, a third live teleconferencing stream.

11. The method of claim 10, further comprising:
while the first peer-to-peer connection and the second peer-to-peer connection are active:
recording the second live teleconferencing stream received from the second computing device via the first peer-to-peer connection, and
recording the third live teleconferencing stream received from the third computing device via the first peer-to-peer connection;
mixing a recording of the second live teleconferencing stream with a recording of the third live teleconferencing stream to generate a composite recording; and
after establishing the Internet connection to the cloud-based teleconferencing service, transmitting the composite recording to the cloud-based teleconferencing service via the Internet connection.

12. A computing device, comprising:
at least one processor; and
memory, storing instructions that, when executed by the at least one processor, cause the computing device to perform a method, the method comprising:
obtaining a meeting identifier associated with a scheduled teleconferencing session;
obtaining a first user identifier corresponding to an invitee of the scheduled teleconferencing session;
determining that a cloud-based teleconferencing service associated with the scheduled teleconferencing session is unavailable;
in response to determining that the cloud-based teleconferencing service is unavailable, transmitting, to a computer system, the meeting identifier and the first user identifier;
receiving, from the computer system, an Internet protocol (IP) address associated with the meeting identifier and the first user identifier;
initiating a first peer-to-peer connection with a second computing device that corresponds to the IP address;
transmitting, to the second computing device via the first peer-to-peer connection, a first live teleconferencing stream; and
receiving, from the second computing device via the first peer-to-peer connection, a second live teleconferencing stream.

13. The computing device of claim 12, wherein the method further comprises:
after initiating the first peer-to-peer connection with the second computing device, receiving authentication information from the second computing device via the first peer-to-peer connection; and
authenticating the second computing device based on the authentication information, wherein transmitting the first live teleconferencing stream to the second computing device is based on authenticating the second computing device.

14. The computing device of claim 13, wherein the method further comprises:
before detecting that the cloud-based teleconferencing session is unavailable, receiving second authentication information via an Internet connection, wherein authenticating the second computing device comprises determining that the authentication information corresponds to the second authentication information.

15. The computing device of claim 12, wherein the method further comprises:
before transmitting the first user identifier:
establishing an Internet connection to the cloud-based teleconferencing service; and
participating in a teleconferencing session with the second computing device via the Internet connection and the cloud-based teleconferencing service, wherein:
determining that the cloud-based teleconferencing service is unavailable comprises detecting, during the teleconferencing session with the second computing device, that the Internet connection to the cloud-based teleconferencing service is unavailable, and
the first user identifier is transmitted to the computer system based on detecting that the Internet connection to the cloud-based teleconferencing service is unavailable.

16. The computing device of claim 12, wherein determining that the cloud-based teleconferencing service is unavailable comprises determining that an Internet connection to the cloud-based teleconferencing service cannot be established, and wherein the first user identifier is transmitted to the second computing device based on determining that the Internet connection to the cloud-based teleconferencing service cannot be established.

17. The computing device of claim 12, wherein the computer system corresponds to a domain name system (DNS) server.

18. The computing device of claim 12, wherein the method further comprises:
before determining that the cloud-based teleconferencing service is unavailable, transmitting, to the computer system, the meeting identifier and a second user identifier corresponding to a user of the computing device.

19. The computing device of claim 12, wherein the method further comprises:
while the first peer-to-peer connection is active, determining that the cloud-based teleconferencing service is available;
in response to determining that the cloud-based teleconferencing service is available and in accordance with a determination that one or more criteria are satisfied, establishing an Internet connection to the cloud-based teleconferencing service; and
transmitting the first live teleconferencing stream to the cloud-based teleconferencing service via the Internet connection.

20. A method performed at a first computing device, the method comprising:
obtaining a meeting identifier associated with a scheduled teleconferencing session;
obtaining a user identifier corresponding to an invitee of the scheduled teleconferencing session;
initiating the scheduled teleconferencing session, including establishing an Internet connection to a cloud-based teleconferencing service associated with the scheduled teleconferencing session and transmitting a first live teleconferencing stream to the cloud-based teleconferencing service via the Internet connection;
while the scheduled teleconferencing session is active, determining that the cloud-based teleconferencing service is unavailable;
in response to determining that the cloud-based teleconferencing service is unavailable, transmitting, to a domain name system (DNS), the meeting identifier and the user identifier;
receiving, from the DNS, an Internet protocol (IP) address associated with the meeting identifier and the user identifier;
initiating a peer-to-peer connection with a second computing device that corresponds to the IP address;
transmitting, to the second computing device via the peer-to-peer connection, the first live teleconferencing stream;
receiving, from the second computing device via the peer-to-peer connection, a second live teleconferencing stream; and
presenting the second live teleconferencing stream.
